(19) United States
(12) Patent Application Publication
(10) Pub. No.: US 2024/0412438 A1
(43) Pub. Date: Dec. 12, 2024

(54) MOUTH SHAPE-BASED METHOD AND APPARATUS FOR GENERATING FACE IMAGE, METHOD AND APPARATUS FOR TRAINING MODEL, AND STORAGE MEDIUM

(71) Applicant: Beijing Baidu Netcom Science Technology Co., Ltd., Beijing (CN)

(72) Inventors: Xirui FAN, Beijing (CN); Yafei ZHAO, Beijing (CN); Zongcai DU, Beijing (CN); Yi CHEN, Beijing (CN); Zhiqiang WANG, Beijing (CN)

(21) Appl. No.: 18/747,627

(22) Filed: Jun. 19, 2024

(30) Foreign Application Priority Data
Aug. 17, 2023 (CN) 202311040269.8

(51) Int. Cl. G06T 13/20; G06T 13/40; G06T 17/20; G10L 15/02; G10L 15/06; G10L 15/18; G10L 25/18

(52) U.S. Cl. CPC G06T 13/205; G06T 13/40; G06T 17/20; G10L 15/02; G10L 15/063; G10L 15/1815; G10L 25/18

(57) ABSTRACT

The present disclosure provides a mouth shape-based method for generating a face image, a method for training a model, and a device, which relates to the field of artificial intelligence, in particular to the field of cloud computing and digital human. The specific implementation solution is as follows: acquiring audio data to be recognized and a preset face image; determining an audio feature of the audio data to be recognized; where the audio feature includes a speech speed feature and a semantic feature; and performing, according to the speech speed feature and the semantic feature, processing on the preset face image, to generate a face image having a mouth shape.

### CROSS-REFERENCE TO RELATED DISCLOSURE

This application claims priority to Chinese Patent Application No. 202311040269.8, filed on Aug. 17, 2023, which is hereby incorporated by reference in its entirety.

### TECHNICAL FIELD

The present disclosure relates to the field of cloud computing and digital human in the field of artificial intelligence, and in particular to a mouth shape-based method and apparatus for generating a face image, a method and apparatus for training a model, and a storage medium.

### BACKGROUND

With the rapid development of artificial intelligence technology, digital human applications have become the mainstream of current research. A face of a digital human may change in response to a speech, for example, an expression and a mouth shape, etc., in a face image of the digital human may change in response to a change of the speech.

One of the core technologies in the digital human applications is audio-driven mouth shape of face technology, and how to make a mouth shape in a face image accurately match audio data is a technical challenge that needs to be solved.

### SUMMARY

The present disclosure provides a mouth shape-based method and apparatus for generating a face image, a method and apparatus for training a model, and a storage medium.

According to a first aspect of the present disclosure, a mouth shape-based method for generating a face image is provided, including:
acquiring audio data to be recognized and a preset face image;
determining an audio feature of the audio data to be recognized; where the audio feature includes a speech speed feature and a semantic feature; and
performing, according to the speech speed feature and the semantic feature, processing on the preset face image, to generate a face image having a mouth shape.

According to a second aspect of the present disclosure, a method for training a model for determining a mouth shape of a face, including:
acquiring image data to be trained and a preset face image; where the image data to be trained includes audio data to be trained and a face image to be trained, the face image to be trained having a mouth shape corresponding to the audio data to be trained;
determining an audio feature of the audio data to be trained; where the audio feature includes a speech speed feature and a semantic feature;
performing, according to the speech speed feature, the semantic feature, and the preset face image, training on an initial model for determining a mouth shape of a face, and obtaining a face image having a mouth shape; and
if the face image having the mouth shape and the face image to be trained are consistent, determining that a trained model for determining a mouth shape of a face is obtained.

According to a third aspect of the present disclosure, an electronic device is provided, including:
at least one processor; and
a memory communicatively connected to the at least one processor; where
the memory stores an instruction executable by the at least one processor, and the instruction is executed by the at least one processor to enable the at least one processor to execute the methods described in the first aspect and the second aspect of the present disclosure.

According to a fourth aspect of the present disclosure, a non-transitory computer readable storage medium storing a computer instruction is provided, where the computer instruction is used for enabling a computer to execute the methods described in the first aspect and the second aspect of the present disclosure.

It should be understood that descriptions in this section are not intended to identify key or important features of embodiments of the present disclosure, nor are they intended to limit scope of the present disclosure. Other features of the present disclosure will be readily understood through the following specification.

### BRIEF DESCRIPTION OF DRAWINGS

Drawings are used for a better understanding of the present solution and do not constitute a limitation on the present disclosure.

FIG. 1 is a flow diagram of a mouth shape-based method for generating a face image provided by an embodiment of the present disclosure.

FIG. 2 is a flow diagram of a mouth shape-based method for generating a face image provided by an embodiment of the present disclosure.

FIG. 3 is a flow diagram of a mouth shape-based method for generating a face image provided by an embodiment of the present disclosure.

FIG. 4 is a flow diagram of a method for training a model for determining a mouth shape of a face provided by an embodiment of the present disclosure.

FIG. 5 is a flow diagram of a method for training a model for determining a mouth shape of a face provided by an embodiment of the present disclosure.

FIG. 6 is a structural diagram of a mouth shape-based apparatus for generating a face image provided by an embodiment of the present disclosure.

FIG. 7 is a structural diagram of a mouth shape-based apparatus for generating a face image provided by an embodiment of the present disclosure.

FIG. 8 is a structural diagram of an apparatus for training a model for determining a mouth shape of a face provided by an embodiment of the present disclosure.

FIG. 9 is a block diagram of an electronic device configured to implement a mouth shape-based method for generating a face image and a method for training a model in an embodiment of the present disclosure.

FIG. 10 is a block diagram of an electronic device configured to implement a mouth shape-based method for generating a face image and a method for training a model in an embodiment of the present disclosure.

### DESCRIPTION OF EMBODIMENTS

Exemplary embodiments of the present disclosure are described below in combination with the drawings, where various details of the embodiments of the present disclosure are included to facilitate understanding, which should be considered merely exemplary. Thus, a person of ordinary skill in the art should be aware that various changes and modifications may be made to the embodiments described herein without departing from scope and spirit of the present disclosure. Similarly, descriptions of well-known functions and structures are omitted from the following description for the sake of clarity and brevity.

In current digital human applications, one of the core technologies is audio-driven mouth shape of face, i.e., a mouth shape in a face image is changed by audio data so that the mouth shape in the face image is adapted to the audio data. Thus, how to achieve a more realistic and accurate mouth shape of face drive is an urgent technical challenge to be solved.

In related mouth shape-based methods for generating a face image, it is difficult to deal with variations of a speech speed, and a speech speed of audio data will have a great impact on a mouth shape. When a same sentence is spoken at different speech speeds, corresponding mouth shapes may be totally different. When a speech speed is low, a mouth shape of each word can be perfectly aligned with a pronunciation. However, when the speech speed increases, a mouth shape in a face image is not accelerated in equal proportion, and a next word may need to be pronounced before a mouth shape is finished. This leads to changes in mouth shapes of many words, various phenomena such as “word missing” and “liaison” will occur, and many mouth shapes will be missed, mixed, or simplified, which affects generation accuracy of a face image.

The present disclosure provides a mouth shape-based method for generating a face image, a method for training a model, and a device, which are applied in the field of cloud computing and digital human in the field of artificial intelligence to improve generation accuracy of a face image having a mouth shape.

It should be noted that a model in the present embodiment is not specific to a particular user and does not reflect personal information of a particular user. It should be noted that face images in the present embodiment are from publicly available datasets.

Handling such as collection, storage, use, processing, transmission, provision and disclosure, etc., of a user's personal information involved in technical solutions of the present disclosure is in compliance with relevant laws and regulations and is not contrary to public order and morals.

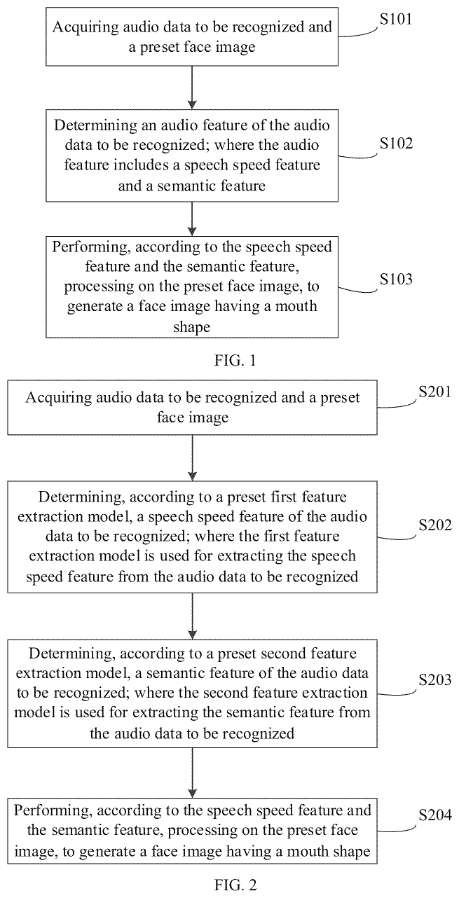

In order to provide the reader with a deeper understanding of implementation principles of the present disclosure, the embodiments are further refined in combination with FIGS. 1-10 below.

FIG. 1 is a flow diagram of a mouth shape-based method for generating a face image provided according to an embodiment of the present disclosure, and the method may be executed by a mouth shape-based apparatus for generating a face image. As shown in FIG. 1, the method includes following steps.

S101, acquiring audio data to be recognized and a preset face image.

For example, a face of a digital human is designed in advance, for example, a face shape, eyes, a nose, a mouth, etc., of the digital human may be designed to generate a preset face image. The digital human may make changes in a mouth shape on the basis of the preset face image, for example, in the preset face image, the mouth of the digital human is in a closed state, and the mouth shape of the digital human may be changed as audio data is emitted.

The audio data to be recognized is audio data prepared in advance, and the mouth shape needs to be changed according to the audio data to be recognized in the face image of the digital human. The audio data to be recognized and the preset face image are acquired. The audio data to be recognized is an audio stream, and the preset face image may be a two-dimensional or three-dimensional image.

S102, determining an audio feature of the audio data to be recognized; where the audio feature includes a speech speed feature and a semantic feature.

For example, after the audio data to be recognized is obtained, feature extraction is performed on the audio data to be recognized to obtain the audio feature of the audio data to be recognized. The audio feature may include the speech speed feature, the semantic feature, etc. The speech speed feature may be used for representing a changing speed of phonemes in the audio data to be recognized, for example, the speech speed feature may be represented as a number of phonemes output in one second, that is, a number of phonemes in the audio data to be recognized and time of the audio data to be recognized may be determined, and the number of phonemes is divided by the time of the audio data to be recognized, to obtain the speech speed of the audio data to be recognized, as the speech speed feature. In the present embodiment, an average speech speed feature of the audio data to be recognized may be determined, and speech speed features corresponding to different phonemes in the audio data to be recognized may also be determined.

The semantic features may be used for representing meanings expressed by the phonemes in the audio data to be recognized. The audio data to be recognized may include a plurality of phonemes, and for the audio data to be recognized, a semantic feature may be determined for each of the phonemes. That is, the audio data to be recognized may be sliced into phonemes to obtain respective phonemes in the audio data to be recognized, and semantic recognition is performed on the phonemes to determine the semantic feature. For example, the semantic recognition may be performed using a preset semantic recognition model, which may be a neural network model. An association relationship between a phoneme and a semantic meaning may also be preset, and semantic features of respective phonemes in the audio data to be recognized are searched according to the preset association relationship as the semantic feature of the audio data to be recognized.

S103, performing, according to the speech speed feature and the semantic feature, processing on the preset face image, to generate a face image having a mouth shape.

For example, after the speech speed feature and the semantic feature is obtained, processing may be performed on the preset face image according to the speech speed feature and the semantic feature, to control the mouth shape in the preset face image to change, to obtain the face image having the mouth shape. For example, if the audio data to be recognized makes a sound “ah”, the mouth shape on the face image is a mouth shape of “ah”. In the present embodiment, the mouth shape in the face image may be determined according to the semantic feature and the speech speed feature to obtain a plurality of face images corresponding to the audio data to be recognized. A face video of the audio data to be recognized may also be determined according to the plurality of face images.

An association relationship between a mouth shape and a speech speed feature and an association relationship between the mouth shape and a semantic feature may be preset, and an association relationship among the mouth shape, the speech speed feature, and the semantic feature may also be preset. A mouth shape corresponding to the speech speed feature and the semantic feature is determined according to a preset association relationship, thereby generating the face image having the mouth shape. A neural network model for determining a mouth shape may also be trained in advance, and the speech speed feature and the semantic feature may be input as input data into the neural network model to output a face image having a mouth shape.

In the present embodiment, the method further includes: if it is determined that a value represented by the speech speed feature of the audio data to be recognized is less than a preset speech speed threshold value, processing may be performed on the preset face image according to the semantic feature, to generate a face image having a mouth shape.

Specifically, when a speech speed is low, a mouth shape of each word can be perfectly aligned with a pronunciation, but when the speech speed is high, a next word may need to be pronounced before a mouth shape is finished, with many mouth shapes missed, mixed, and simplified, etc.

A speech speed threshold value is preset, and after the speech speed feature is obtained, the value represented by the speech speed feature may be compared with the preset speech speed threshold. If it is determined that the value represented by the speech speed feature of the audio data to be recognized is equal to or greater than the preset speech speed threshold, it is indicated that the speech speed is high, and processing may be performed on the preset face image according to the speech speed feature and the semantic feature to generate a face image having a mouth shape.

If it is determined that the value represented by the speech speed feature of the audio data to be recognized is less than the preset speech speed threshold, it is determined that the speech speed of the audio data to be recognized is low, and processing may be performed on the preset face image only by the semantic feature to generate a face image having a mouth shape. For example, only the semantic feature may be used as input data for the preset neural network model, for processing such as convolution, etc., on the semantic features, reducing amount of computation during face image processing.

A beneficial effect of such a setting is that when the speech speed of the audio data to be recognized is low, an accurate mouth shape can also be obtained according to only the semantic feature, reducing the amount of computation and improving generation efficiency of a face image.

In the embodiment of the present disclosure, the audio data to be recognized is acquired, and the speech speed feature and the semantic feature are determined from the audio data to be recognized. Processing is performed on the preset face image in combination with the speech speed feature and the semantic feature. The preset face image is an initial image on which a mouth shape is based when the mouth shape changes, and can represent an appearance of a face. Face images having different mouth shapes are generated according to the speech speed feature and the semantic feature, to match a mouth shape of a face image with the audio data to be recognized. The problem of word missing and liaison of a mouth shape of a face image when a speech speed is high is solved. Accurate driving of a mouth shape in a face image is realized, improving determination accuracy of the face image.

FIG. 2 is a flow diagram of a mouth shape-based method for generating a face image provided by an embodiment of the present disclosure, which is an embodiment based on the above embodiments.

In the present embodiment, the determining the audio feature of the audio data to be recognized may be refined as: determining, according to a preset first feature extraction model, the speech speed feature of the audio data to be recognized; where the first feature extraction model is used for extracting the speech speed feature from the audio data to be recognized; and determining, according to a preset second feature extraction model, the semantic feature of the audio data to be recognized; where the second feature extraction model is used for extracting the semantic feature from the audio data to be recognized.

As shown in FIG. 2, the method includes following steps.

S201, acquiring audio data to be recognized and a preset face image.

For example, this step can be referred to the aforementioned step S101 and is not repeated.

S202, determining, according to a preset first feature extraction model, a speech speed feature of the audio data to be recognized; where the first feature extraction model is used for extracting the speech speed feature from the audio data to be recognized.

For example, a first feature extraction model is preset, which may be a predetermined neural network model and is used for extracting the speech speed feature from the audio data to be recognized. The audio data to be recognized is input into the first feature extraction model for processing to obtain the speech speed feature of the audio data to be recognized. For example, the first feature extraction model may include a network layer such as a convolutional layer, a pooling layer, etc., which may perform convolution processing and feature extraction on the audio data to be recognized, to obtain the speech speed feature of the audio data to be recognized. In the present embodiment, a network structure of the first feature extraction model is not specifically limited.

In the present embodiment, the determining, according to the preset first feature extraction model, the speech speed feature of the audio data to be recognized includes: inputting the audio data to be recognized into the preset first feature extraction model for feature extraction, to obtain a phonetic posterioriorgram feature of the audio data to be recognized; where the phonetic posterioriorgram feature represents information about a phoneme category of the audio data to be recognized; and determining, according to the phonetic posterioriorgram feature of the audio data to be recognized, the speech speed feature of the audio data to be recognized.

Specifically, the first feature extraction model may be an ASR (Automatic Speech Recognition) model, and the ASR model may include a plurality of network layers, which may include, for example, a convolutional layer, a pooling layer, and a fully-connected layer. The audio data to be recognized is input into a preset ASR model for feature extraction, for example, the feature extraction may be performed by a convolutional layer to obtain PPG (Phonetic Posterioriorgram) feature of the audio data to be recognized. A PPG feature is a time-to-category matrix which can represent a posterior probability of each speech category for each specific time frame of a discourse. The PPG feature may be represented as an image with a two-dimensional coordinate axis representing information about the phoneme category of the audio data to be recognized, with a horizontal coordinate representing time and a vertical coordinate representing the phoneme category.

After the PPG feature is obtained, a computation may be performed on the PPG feature according to a preset speech speed determination algorithm to convert the PPG feature into the speech speed feature of the audio data to be recognized. A changing speed of phonemes may be computed to be the speech speed, realizing explicit modeling of a speech speed feature. In the present embodiment, the preset speech speed determination algorithm is not specifically limited.

A beneficial effect of such a setting is that the audio data to be recognized is input into the automatic speech recognition model for processing to obtain the PPG feature of the audio data to be recognized, and the PPG feature is further computed to obtain the speech speed feature. Explicit modeling of a speech speed is realized, thereby introducing a speech speed feature, which greatly improves accuracy and realism of an audio-driven mouth shape when the speech speed changes.

In the present embodiment, the determining, according to the phonetic posterioriorgram feature of the audio data to be recognized, the speech speed feature of the audio data to be recognized includes: performing a fast Fourier transform processing on the phonetic posterioriorgram feature to obtain a frequency domain signal feature; where the frequency domain signal feature represents information about the phoneme category of the audio data to be recognized; slicing, according to a preset frequency band size, the frequency domain signal feature, into frequency domain signal features in at least two frequency bands; and performing integrating processing on the frequency domain signal features in the at least two frequency bands, to obtain the speech speed feature of the audio data to be recognized.

Specifically, the PPG feature is a time-domain signal, and after the PPG feature of the audio data to be recognized is obtained, a fast Fourier transform processing may be performed on the PPG feature. That is, the PPG feature is converted to a frequency domain by the FFT (Fast Fourier Transform), to obtain the frequency domain signal feature corresponding to the PPG feature. The frequency domain signal feature may also be represented as information about the phoneme category of the audio data to be recognized.

Gradual integrating in frequency bands is performed on the frequency domain signal feature to compute a desired frequency as the speech speed, that is, the speech speed feature of the audio data to be recognized is obtained. When the speech speed feature is being computed, a frequency band size may be preset, and the frequency domain signal feature is sliced according to the preset frequency band size, to obtain frequency domain signal features with a plurality of frequency band sizes. Integrating processing is performed on the frequency domain signal features with respective frequency band sizes one by one, and an integrating result may be used to represent a changing speed of phonemes in the audio data to be recognized, that is, the speech speed feature.

A beneficial effect of such a setting is that by performing FFT processing and integral computation, the PPG feature can be converted to a specific speech speed, to realize determination of the speech speed feature, thereby improving generation accuracy of a face image.

S203, determining, according to a preset second feature extraction model, a semantic feature of the audio data to be recognized; where the second feature extraction model is used for extracting the semantic feature from the audio data to be recognized.

For example, the second feature extraction model may also be a pre-trained neural network model, e.g., the second feature extraction model is a preset semantic recognition model. The second feature extraction model includes a feature extraction network, and semantic feature extraction may be performed on the audio data to be recognized according to the preset second feature extraction model, to obtain the semantic feature of the audio data to be recognized.

Through the first feature extraction model and the second feature extraction model, the speech speed feature and the semantic feature can be obtained quickly, to realize respective extraction of the speech speed feature and the semantic feature, which improves efficiency of feature extraction, thus improving the generation efficiency of a face image.

In the present embodiment, the determining, according to the preset second feature extraction model, the semantic feature of the audio data to be recognized includes: inputting the audio data to be recognized into the preset second feature extraction model for feature extraction, to obtain output semantic feature of the audio data to be recognized.

Specifically, the second feature extraction model may be a semantic recognition model, and network layers such as a plurality of convolutional layers may be included in the semantic recognition model to form the feature extraction network. The audio data to be recognized is input into a preset semantic recognition model for processing, for example, feature extraction may be performed by a convolutional layer to obtain the semantic feature of the audio data to be recognized. The audio data to be recognized is streaming data and the extracted semantic feature may be a streaming feature. In the present embodiment, a model structure of the semantic recognition model is not specifically limited.

A beneficial effect of such a setting is that automatic extraction of a semantic feature is performed on the input audio streaming data, improving efficiency and accuracy of determining the semantic feature, and thus improving efficiency and accuracy of generating a face image.

S204, performing, according to the speech speed feature and the semantic feature, processing on the preset face image, to generate a face image having a mouth shape.

For example, this step can be referred to the aforementioned step S103 and is not repeated.

In the embodiment of the present disclosure, the audio data to be recognized is acquired, and the speech speed feature and the semantic feature are determined from the audio data to be recognized. Processing is performed on the preset face image in combination with the speech speed feature and the semantic feature. The preset face image is an initial image on which a mouth shape is based when the mouth shape changes, and can represent an appearance of a face. Face images having different mouth shapes are generated according to the speech speed feature and the semantic feature, to match a mouth shape of a face image with the audio data to be recognized. The problem of word missing and liaison of a mouth shape of a face image when a speech speed is high is solved. Accurate driving of a mouth shape in a face image is realized, improving determination accuracy of the face image.

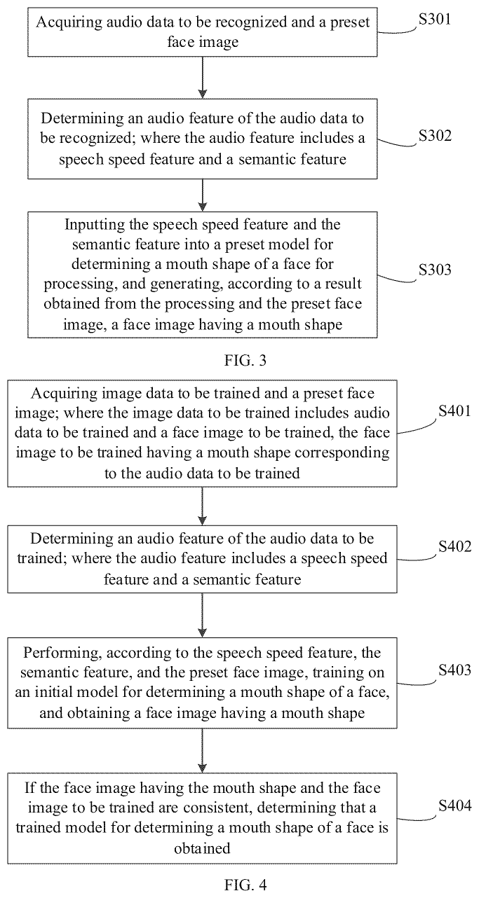

FIG. 3 is a flow diagram of a mouth shape-based method for generating a face image provided by an embodiment of the present disclosure, which is an embodiment based on the above embodiments.

In the present embodiment, the performing, according to the speech speed feature and the semantic feature, the processing on the preset face image, to generate the face image having the mouth shape may be refined as: inputting the speech speed feature and the semantic feature into a preset model for determining a mouth shape of a face for processing, and generating, according to a result obtained from the processing and the preset face image, the face image having the mouth shape.

As shown in FIG. 3, the method includes following steps.

S301, acquiring audio data to be recognized and a preset face image.

For example, this step can be referred to the aforementioned step S101 and is not repeated.

S302, determining an audio feature of the audio data to be recognized; where the audio feature includes a speech speed feature and a semantic feature.

For example, this step can be referred to the aforementioned step S102 and is not repeated.

S303, inputting the speech speed feature and the semantic feature into a preset model for determining a mouth shape of a face for processing, and generating, according to a result obtained from the processing and the preset face image, the face image having the mouth shape.

For example, a model for determining a mouth shape of a face is constructed and trained in advance, and the model for determining the mouth shape of the face is a neural network model which can be used to output a face image having a mouth shape. The speech speed feature and the semantic feature are used as input data to be input into the preset model for determining the mouth shape of the face for processing. After the processing, the model for determining the mouth shape of the face may make changes to a mouth shape of the preset face image according to a processing result, to obtain the face image having the mouth shape. For example, the processing result determined according to the speech speed feature and the semantic feature by the model for determining the mouth shape of the face may be size information and shape information of the mouth shape, and the preset face image is rendered according to the determined size information and shape information of the mouth shape, to generate the face image having the mouth shape. By using the model for determining the mouth shape of the face, the face image can be obtained quickly in combination with the speech speed feature and the semantic feature, avoiding a problem that an effect of audio-driven mouth shape of face declines due to changes of a speech speed, and improving efficiency and accuracy of generating the face image.

In the present embodiment, the inputting the speech speed feature and the semantic feature into the preset model for determining the mouth shape of the face for processing, and the generating, according to the result obtained from the processing and the preset face image, the face image having the mouth shape include: performing, based on the preset model for determining the mouth shape of the face, splicing processing on the speech speed feature and the semantic feature, to obtain a spliced feature of the audio data to be recognized; where the spliced feature represents the speech speed feature and the semantic feature; performing, according to a convolutional layer in the preset model for determining the mouth shape of the face, feature extraction on the spliced feature, to obtain a face driving parameter; where the face driving parameter is used for representing a parameter required to drive a mouth shape change in a face image; and performing, according to the face driving parameter, image rendering on the preset face image, to generate the face image having the mouth shape.

Specifically, the speech speed feature and the semantic feature are input into the preset model for determining the mouth shape of the face. The splicing process may be performed on the speech speed feature and the semantic feature according to the model for determining the mouth shape of the face, for example, a matrix represented by the speech speed feature may be merged with a matrix represented by the semantic feature. Spliced data is determined as the spliced feature of the audio data to be recognized. That is, the spliced feature can represent the speech speed feature and the semantic feature.

A network layer such as a convolutional layer is provided in the model for determining the mouth shape of the face, and when the spliced feature passes through the convolutional layer of the model for determining the mouth shape of the face, feature extraction may be performed on the spliced feature according to the convolutional layer, and the face driving parameter is obtained by computation. The face driving parameter is a parameter required to drive a mouth shape in a face image to make changes. For example, the face driving parameter may be position information and size information, etc., of a target box having a mouth shape in a face image. After the face driving parameter is obtained, image rendering is performed on the preset face image, to enable a mouth shape in the preset face image to be changed from an original closed shape to a shape corresponding to the face driving parameter, to obtain the face image having the mouth shape. For a piece of audio data to be recognized, a plurality of face images with different mouth shapes may be generated.

A beneficial effect of such a setting is that the speech speed feature and the semantic feature are spliced, and the parameter required to drive the mouth shape of the face is obtained by a driving network of the model for determining the mouth shape of the face, so that a mouth shape in a generated face image is adapted to the audio data to be recognized, reducing impact of a speech speed on the mouth shape in the face image, and improving efficiency and accuracy of generating a face image.

In the present embodiment, the face driving parameter is a weight parameter of a blend shape; and the performing, according to the face driving parameter, the image rendering on the preset face image, to generate the face image having the mouth shape includes: determining, according to the weight parameter of the blend shape, facial three-dimensional mesh data corresponding to the preset face image; where the facial three-dimensional mesh data is data representing a three-dimensional mesh model of a facial surface on a face image; and performing, according to the facial three-dimensional mesh data, image rendering on the preset face image, to generate the face image having the mouth shape.

Specifically, the face driving parameter may be a weight of a blend shape, which is obtained by the driving network in the model for determining the mouth shape of the face. The face image having the mouth shape may be obtained according to the weight parameter of the blend shape, based on a preset rendering engine, and on the basis of the preset face image. For example, the preset rendering engine may be the Unreal rendering engine.

When the image rendering is performed, the facial three-dimensional mesh data may first be determined according to the weight of the blend shape. The facial three-dimensional mesh data may be used to represent data of a three-dimensional mesh model of a facial surface on the face image. A facial three-dimensional mesh may be determined based on the weight of the blend shape and a base of the blend shape. The base of the blend shape is related to portrait binding and is a fixed preset parameter. After the facial three-dimensional mesh data is obtained, the image rendering is then performed on the face image, to obtain the face image having the mouth shape.

A beneficial effect of such a setting is that the facial three-dimensional mesh is first obtained according to the weight of the blend shape, and then the face image is obtained based on the facial three-dimensional mesh. Accurate generation of a face image is realized, facilitating a user's experience of a digital human.

In the embodiment of the present disclosure, the audio data to be recognized is acquired, and the speech speed feature and the semantic feature are determined from the audio data to be recognized. Processing is performed on the preset face image in combination with the speech speed feature and the semantic feature. The preset face image is an initial image on which a mouth shape is based when the mouth shape changes, and can represent an appearance of a face. Face images having different mouth shapes are generated according to the speech speed feature and the semantic feature, to match a mouth shape of a face image with the audio data to be recognized. The problem of word missing and liaison of a mouth shape of a face image when a speech speed is high is solved. Accurate driving of a mouth shape in a face image is realized, improving determination accuracy of the face image.

FIG. 4 is a flow diagram of a method for training a model for determining a mouth shape of a face provided according to an embodiment of the present disclosure, and the method may be executed by a training apparatus for a model for determining a mouth shape of a face. As shown in FIG. 4, the method includes following steps.

S401, acquiring image data to be trained and a preset face image; where the image data to be trained includes audio data to be trained and a face image to be trained, the face image to be trained having a mouth shape corresponding to the audio data to be trained.

For example, when a face image having a mouth shape is determined, a deep learning-based model for determining the mouth shape of the face may be used. The model for determining the mouth shape of the face can implement the face image generation method described in any one of the aforementioned embodiments, and the model for determining the mouth shape of the face needs to be pre-trained before being used. Image data to be trained and a preset face image which are collected in advance are acquired. The image data to be trained may include audio data to be trained and a face image to be trained, where the audio data to be trained is an audio stream used to train a model, and the face image to be trained has a mouth shape matching the audio data to be trained.

The preset face image is a pre-designed face image of a digital human having a mouth, and the preset face image may further include five facial features such as eyes and a nose, etc. A face shape, eyes, a nose and a mouth of the digital human may be designed, to generate a preset face image. The digital human may make changes in a mouth shape on the basis of the preset face image, for example, in the preset face image, the mouth of the digital human is in a closed state, and the mouth shape of the digital human may be changed as audio data is emitted. Difference between the face image to be trained and the preset face image is that the mouth shape has changed.

In the present embodiment, the acquiring the image data to be trained includes: acquiring the audio data to be trained; performing, according to the audio data to be trained, three-dimensional reconstruction processing of a face image, to obtain facial three-dimensional mesh data corresponding to the audio data to be trained; and obtaining, according to the facial three-dimensional mesh data corresponding to the audio data to be trained, the face image to be trained.

Specifically, a training set which is collected in advance is acquired, and the training set may be audio data to be trained. Based on the audio data to be trained, a face image to be trained is generated. The face image to be trained has a mouth shape, and the mouth shape in the face image to be trained is adapted to the audio data to be trained.

Three-dimensional reconstruction processing of the face image may be performed according to the audio data to be trained, for example, three-dimensional reconstruction of each frame of the face image may be performed according to respective phonemes of the audio data to be trained. In the present embodiment, a processing process of the three-dimensional reconstruction is not specifically limited. Facial three-dimensional mesh data is determined frame by frame, that is, facial three-dimensional meshes of multi-frame face images corresponding to the audio data to be trained can be obtained. According to the facial three-dimensional meshes corresponding to the audio data to be trained, the multi-frame face images to be trained are obtained.

A beneficial effect of such a setting is that a face image corresponding to the audio data to be trained is predetermined, which facilitates training of the model for determining the mouth shape of the face and improves training efficiency and accuracy of the model for determining the mouth shape of the face.

S402, determining an audio feature of the audio data to be trained; where the audio feature includes a speech speed feature and a semantic feature.

For example, after the audio data to be trained is obtained, feature extraction is performed on the audio data to be trained to obtain the audio feature of the audio data to be trained. The audio feature may include the speech speed feature, the semantic feature, etc. The speech speed feature may be used for representing a changing speed of phonemes in the audio data to be trained, for example, the speech speed feature may be represented as a number of phonemes output in one second, that is, a number of phonemes in the audio data to be trained and time of the audio data to be trained may be determined, and the number of phonemes is divided by the time of the audio data to be trained, to obtain the speech speed of the audio data to be trained, as the speech speed feature. In the present embodiment, an average speech speed feature of the audio data to be trained may be determined, and speech speed features corresponding to different phonemes in the audio data to be trained may also be determined.

The semantic features may be used for representing meanings expressed by the audio data to be trained. The audio data to be trained may include a plurality of phonemes, and for the audio data to be trained, a semantic feature may be determined for each of the phonemes. That is, the audio data to be trained may be sliced into phonemes to obtain respective phonemes in the audio data to be trained, and semantic recognition is performed on the phonemes to determine the semantic feature. For example, the semantic recognition may be performed using a preset semantic recognition model, which may be a neural network model. An association relationship between a phoneme and a semantic meaning may also be preset, and semantic features of all phonemes in the audio data to be trained are searched according to the preset association relationship as the semantic feature of the audio data to be trained.

S403, performing, according to the speech speed feature, the semantic feature, and the preset face image, training on an initial model for determining a mouth shape of a face, and obtaining a face image having a mouth shape.

For example, the speech speed feature and the semantic feature of the audio data to be trained are input into a to-be-trained model for determining a mouth shape of a face for iterative training. At each iteration, a face image having a mouth shape is generated according to a result obtained from processing and the preset face image.

A to-be-trained model for determining a mouth shape of a face is constructed in advance, and the speech speed feature and the semantic feature are used as input data to be input into the to-be-trained model for determining the mouth shape of the face for processing. After the processing, the model for determining the mouth shape of the face may make changes to a mouth shape of the preset face image according to a processing result, to obtain face images having different mouth shapes. For example, the processing result determined according to the speech speed feature and the semantic feature by the model for determining the mouth shape of the face may be size information and shape information of the mouth shape, and the preset face image is rendered according to the determined size information and shape information of the mouth shape, to generate a face image having the mouth shape. The audio data to be trained includes a plurality of phonemes, and face images having a mouth shape which correspond to respective phonemes may be generated.

S404, if the face image having the mouth shape and the face image to be trained are consistent, determining that a trained model for determining a mouth shape of a face is obtained.

For example, after a face image having a mouth shape output by the model is obtained, a face image having a mouth shape which corresponds to a phoneme is compared with a face image to be trained which corresponds to the phoneme, and if the two are consistent, it is determined that training of the model for determining the mouth shape of the face is complete; and if the two are inconsistent, it is determined that further training of the model for determining the mouth shape of the face is required, the semantic feature and the speech speed feature of the audio data to be trained continue to input into the model for determining the mouth shape of the face, and training is performed based on a preset back propagation algorithm until an output face image having a mouth shape is consistent with a corresponding face image to be trained.

A similarity threshold value may further be preset, and the similarity threshold value can be used for determining whether training of a model for determining a mouth shape of a face is complete. After a face image having a mouth shape is obtained, a similarity between the face image having the mouth shape and a corresponding face image to be trained is determined. If the determined similarity is equal to or greater than the preset similarity threshold value, it is determined that the training of the model for determining the mouth shape of the face is complete; and if the similarity is less than the preset similarity threshold value, it is determined that the training of the model for determining the mouth shape of the face is incomplete.

In the embodiment of the present disclosure, the audio data to be trained and the face image to be trained are acquired, and the speech speed feature and the semantic feature are determined from the audio data to be trained. In combination with the speech speed feature and the semantic feature, training is performed on the to-be-trained model for determining the mouth shape of the face. According to the speech speed feature and the semantic feature, face images having different mouth shapes are generated, and a mouth shape in an output face image is enabled to match the audio data to be trained through the training. This causes the model to learn effects of different speech speeds on a mouth shape, which greatly improves accuracy and realism of an audio-driven mouth shape when a speech speed changes, and facilitates improving determination accuracy of a face image when the model for determining the mouth shape of the face is used later.

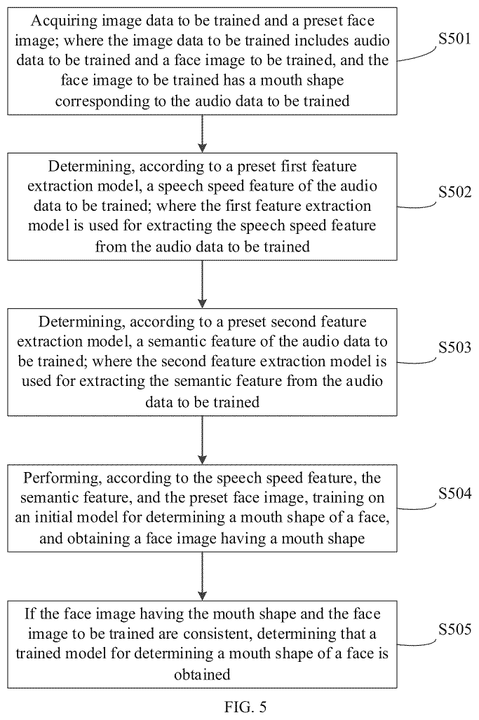

FIG. 5 is a flow diagram of a method for training a model for determining a mouth shape of a face provided according to an embodiment of the present disclosure, which is an embodiment based on the above embodiments.

In the present embodiment, the determining the audio feature of the audio data to be trained may be refined as: determining, according to a preset first feature extraction model, the speech speed feature of the audio data to be trained; where the first feature extraction model is used for extracting the speech speed feature from the audio data to be trained; and determining, according to a preset second feature extraction model, the semantic feature of the audio data to be trained; where the second feature extraction model is used for extracting the semantic feature from the audio data to be trained.

As shown in FIG. 5, the method includes following steps.

S501, acquiring image data to be trained and a preset face image; where the image data to be trained includes audio data to be trained and a face image to be trained, and the face image to be trained has a mouth shape corresponding to the audio data to be trained.

For example, this step can be referred to the aforementioned step S401 and is not repeated.

S502, determining, according to a preset first feature extraction model, a speech speed feature of the audio data to be trained; where the first feature extraction model is used for extracting the speech speed feature from the audio data to be trained.

For example, a first feature extraction model is preset, which may be a predetermined neural network model and is used for extracting the speech speed feature from the audio data to be trained. The audio data to be trained is input into the first feature extraction model for processing to obtain the speech speed feature of the audio data to be trained. For example, the first feature extraction model may include a network layer such as a convolutional layer, a pooling layer, etc., which may perform convolution processing and feature extraction on the audio data to be trained, to obtain the speech speed feature of the audio data to be trained. In the present embodiment, a network structure of the first feature extraction model is not specifically limited.

In the present embodiment, the determining, according to the preset first feature extraction model, the speech speed feature of the audio data to be trained includes: inputting the audio data to be trained into the preset first feature extraction model for feature extraction, to obtain a phonetic posterioriorgram feature of the audio data to be trained; where the phonetic posterioriorgram feature represents information about a phoneme category of the audio data to be trained; and determining, according to the phonetic posterioriorgram feature of the audio data to be trained, the speech speed feature of the audio data to be trained.

Specifically, the first feature extraction model may be an ASR model, and the ASR model may include a plurality of network layers, which may include, for example, a convolutional layer, a pooling layer, and a fully-connected layer. The audio data to be trained is input into a preset ASR model for feature extraction, for example, the feature extraction may be performed by a convolutional layer to obtain a PPG feature of the audio data to be trained. The PPG feature is a time-to-category matrix which can represent a posterior probability of each speech category for each specific time frame of a discourse. The PPG feature may be represented as an image with a two-dimensional coordinate axis representing information about the phoneme category of the audio data to be trained, with a horizontal coordinate representing time and a vertical coordinate representing the phoneme category.

After the PPG feature is obtained, a computation may be performed on the PPG feature according to a preset speech speed determination algorithm to convert the PPG feature into the speech speed feature of the audio data to be trained. A changing speed of phonemes may be computed to be the speech speed, realizing explicit modeling of a speech speed feature. In the present embodiment, the preset speech speed determination algorithm is not specifically limited.

A beneficial effect of such a setting is that the audio data to be trained is input into the automatic speech recognition model for processing to obtain the PPG feature of the audio data to be trained, and the PPG feature is further computed to obtain the speech speed feature. Explicit modeling of a speech speed is realized, thereby introducing a speech speed feature, which greatly improves accuracy and realism of an audio-driven mouth shape when the speech speed changes.

In the present embodiment, the determining, according to the phonetic posterioriorgram feature of the audio data to be trained, the speech speed feature of the audio data to be trained includes: performing a fast Fourier transform processing on the phonetic posterioriorgram feature to obtain a frequency domain signal feature; where the frequency domain signal feature represents information about the phoneme category of the audio data to be trained; slicing, according to a preset frequency band size, the frequency domain signal feature, into frequency domain signal features in at least two frequency bands; and performing integrating processing on the frequency domain signal features in the at least two frequency bands, to obtain the speech speed feature of the audio data to be trained.

Specifically, the PPG feature is a time-domain signal, and after the PPG feature of the audio data to be trained is obtained, a fast Fourier transform processing may be performed on the PPG feature. That is, the PPG feature is converted to a frequency domain by the FFT, to obtain the frequency domain signal feature corresponding to the PPG feature. The frequency domain signal feature may also be represented as information about the phoneme category of the audio data to be trained.

Gradual integrating in frequency bands is performed on the frequency domain signal feature to compute a desired frequency as the speech speed, that is, the speech speed feature of the audio data to be trained is obtained. When the speech speed feature is being computed, a frequency band size may be preset, and the frequency domain signal feature is sliced according to the preset frequency band size, to obtain frequency domain signal features with a plurality of frequency band sizes. Integrating processing is performed on the frequency domain signal features with respective frequency band sizes one by one, and an integrating result may be used to represent a changing speed of phonemes in the audio data to be trained, that is, the speech speed feature.

A beneficial effect of such a setting is that by performing FFT processing and integral computation, the PPG feature can be converted to a specific speech speed, to realize determination of the speech speed feature, thereby improving training accuracy of a model for determining a mouth shape of a face.

S503, determining, according to a preset second feature extraction model, a semantic feature of the audio data to be trained; where the second feature extraction model is used for extracting the semantic feature from the audio data to be trained.

For example, the second feature extraction model may also be a pre-trained neural network model, e.g., the second feature extraction model is a preset semantic recognition model. The second feature extraction model includes a feature extraction network, and semantic feature extraction may be performed on the audio data to be trained according to a feature extraction network in the second feature extraction model, to obtain the semantic feature of the audio data to be trained.

Through the first feature extraction model and the second feature extraction model, the speech speed feature and the semantic feature can be obtained quickly, to realize respective extraction of the speech speed feature and the semantic feature, which improves efficiency of feature extraction, thus improving the training accuracy of the model for determining the mouth shape of the face.

In the present embodiment, the determining, according to the preset second feature extraction model, the semantic feature of the audio data to be trained includes: inputting the audio data to be trained into the preset second feature extraction model for feature extraction, to obtain output semantic feature of the audio data to be trained.

Specifically, the second feature extraction model may be a semantic recognition model, and network layers such as a plurality of convolutional layers may be included in the semantic recognition model to form the feature extraction network. The audio data to be trained is input into a preset semantic recognition model for processing, for example, feature extraction may be performed by a convolutional layer to obtain the semantic feature of the audio data to be trained. The audio data to be trained is streaming data and the extracted semantic feature may be a streaming feature. In the present embodiment, a model structure of the semantic recognition model is not specifically limited.

A beneficial effect of such a setting is that automatic extraction of a semantic feature is performed on the input audio streaming data, improving efficiency and accuracy of determining the semantic feature, and thus improving the training efficiency and accuracy of the model for determining the mouth shape of the face.

S504, performing, according to the speech speed feature, the semantic feature, and the preset face image, training on an initial model for determining a mouth shape of a face, and obtaining a face image having a mouth shape.

For example, the speech speed feature and the semantic feature are input into a to-be-trained model for determining a mouth shape of a face for training. Processing is performed on the semantic feature and the speech speed feature by the to-be-trained model for determining the mouth shape of the face, and a face image having a mouth shape is generated according to a result obtained from the processing and the preset face image.

In the present embodiment, the performing, according to the speech speed feature, the semantic feature, and the preset face image, the training on the initial model for determining the mouth shape of the face, and the obtaining the face image having the mouth shape includes: performing, based on the initial model for determining the mouth shape of the face, splicing processing on the speech speed feature and the semantic feature, to obtain a spliced feature of the audio data to be trained; where the spliced feature represents the speech speed feature and the semantic feature; performing, according to a convolutional layer in the initial model for determining the mouth shape of the face, feature extraction on the spliced feature, to obtain a face driving parameter; where the face driving parameter is used for representing a parameter required to drive a mouth shape change in a face image; and performing, according to the face driving parameter, image rendering on the preset face image, to obtain the face image having the mouth shape.

Specifically, the speech speed feature and the semantic feature are input into the to-be-trained model for determining the mouth shape of the face. The splicing process may be performed on the speech speed feature and the semantic feature according to the model for determining the mouth shape of the face, for example, a matrix represented by the speech speed feature may be merged with a matrix represented by the semantic feature. Spliced data is determined as the spliced feature of the audio data to be trained. That is, the spliced feature can represent the speech speed feature and the semantic feature.

A network layer such as a convolutional layer is provided in the model for determining the mouth shape of the face, and when the spliced feature passes through the convolutional layer of the model for determining the mouth shape of the face, feature extraction may be performed on the spliced feature according to the convolutional layer, and the face driving parameter is obtained by computation. The face driving parameter is a parameter required to drive a mouth shape in a face image to make changes. For example, the face driving parameter may be position information and size information, etc., of a target box having a mouth shape in a face image. After the face driving parameter is obtained, image rendering is performed on the preset face image, to cause a mouth shape in the preset face image to be changed from an original closed shape to a shape corresponding to the face driving parameter, to obtain the face image having the mouth shape.

A beneficial effect of such a setting is that the speech speed feature and the semantic feature are spliced, and the parameter required to drive the mouth shape of the face is obtained by a driving network of the model for determining the mouth shape of the face, so that a mouth shape in a generated face image is adapted to the audio data to be trained through training, reducing impact of a speech speed on the mouth shape in the face image, and improving the training accuracy of the model for determining the mouth shape of the face.

In the present embodiment, the face driving parameter is a weight parameter of a blend shape; and the performing, according to the face driving parameter, the image rendering on the preset face image, to obtain the face image having the mouth shape includes: determining, according to the weight parameter of the blend shape, facial three-dimensional mesh data corresponding to the preset face image; where the facial three-dimensional mesh data is data representing a three-dimensional mesh model of a facial surface on a face image; and performing, according to the facial three-dimensional mesh data, image rendering on the preset face image, to generate the face image having the mouth shape.

Specifically, the face driving parameter may be a weight of a blend shape, which is obtained by the driving network in the model for determining the mouth shape of the face. The face image having the mouth shape may be obtained according to the weight parameter of the blend shape, based on a preset rendering engine, and on the basis of the preset face image. For example, the preset rendering engine may be the Unreal rendering engine.

When the image rendering is performed, the facial three-dimensional mesh data may first be determined according to the weight of the blend shape. The facial three-dimensional mesh data may be used to represent data of a three-dimensional mesh model of a facial surface on the face image. A facial three-dimensional mesh may be determined based on the weight of the blend shape and a base of the blend shape. The base of the blend shape is related to portrait binding and is a fixed preset parameter. After the facial three-dimensional mesh data is obtained, the image rendering is then performed on the face image, to obtain the face image having the mouth shape.

A beneficial effect of such a setting is that the facial three-dimensional mesh is first obtained according to the weight of the blend shape, and then the face image is obtained based on the facial three-dimensional mesh, realizing accurate generation of the face image, and improving the training accuracy of the model for determining the mouth shape of the face.

S505, if the face image having the mouth shape and the face image to be trained are consistent, determining that a trained model for determining a mouth shape of a face is obtained.

For example, this step can be referred to the aforementioned step S404 and is not repeated.

In the embodiment of the present disclosure, the audio data to be trained and the face image to be trained are acquired, and the speech speed feature and the semantic feature are determined from the audio data to be trained. In combination with the speech speed feature and the semantic feature, training is performed on the to-be-trained model for determining the mouth shape of the face. According to the speech speed feature and the semantic feature, face images having different mouth shapes are generated, and a mouth shape in an output face image is caused to match the audio data to be trained through the training. This causes the model to learn effects of different speech speeds on a mouth shape, which greatly improves accuracy and realism of an audio-driven mouth shape when a speech speed changes, and facilitates improving determination accuracy of a face image when the model for determining the mouth shape of the face is used later.

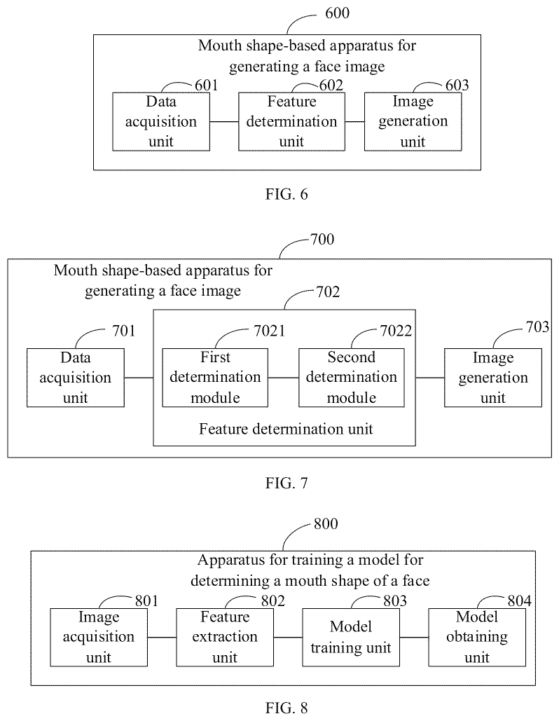

FIG. 6 is a structural diagram of a mouth shape-based apparatus for generating a face image provided by an embodiment of the present disclosure. For ease of illustration, only parts relevant to the embodiment of the present disclosure are shown. Referring to FIG. 6, the mouth shape-based apparatus 600 for generating the face image includes: a data acquisition unit 601, a feature determination unit 602, and an image generation unit 603.

The data acquisition unit 601 is configured to acquire audio data to be recognized and a preset face image;
the feature determination unit 602 is configured to determine an audio feature of the audio data to be recognized; where the audio feature includes a speech speed feature and a semantic feature; and
the image generation unit 603 is configured to perform, according to the speech speed feature and the semantic feature, processing on the preset face image, to generate a face image having a mouth shape.

FIG. 7 is a structural diagram of a mouth shape-based apparatus for generating a face image provided by an embodiment of the present disclosure, and as shown in FIG. 7, the mouth shape-based apparatus 700 for generating the face image includes a data acquisition unit 701, a feature determination unit 702, and an image generation unit 703, where the feature determination unit 702 includes a first determination module 7021 and a second determination module 7022.

The first determination module 7021 is configured to determine, according to a preset first feature extraction model, a speech speed feature of audio data to be recognized; where the first feature extraction model is used for extracting the speech speed feature from the audio data to be recognized; and
the second determination module 7022 is configured to determine, according to a preset second feature extraction model, a semantic feature of the audio data to be recognized; where the second feature extraction model is used for extracting the semantic feature from the audio data to be recognized.

In an example, the first determination module 7021 includes:
a feature extraction sub-module, configured to input the audio data to be recognized into the preset first feature extraction model for feature extraction, to obtain a phonetic posterioriorgram feature of the audio data to be recognized; where the phonetic posterioriorgram feature represents information about a phoneme category of the audio data to be recognized; and
a feature determination sub-module, configured to determine, according to the phonetic posterioriorgram feature of the audio data to be recognized, the speech speed feature of the audio data to be recognized.

In an example, the feature determination sub-module is specifically configured to:
perform a fast Fourier transform processing on the phonetic posterioriorgram feature to obtain a frequency domain signal feature; where the frequency domain signal feature represents information about the phoneme category of the audio data to be recognized;
slice, according to a preset frequency band size, the frequency domain signal feature into frequency domain signal features in at least two frequency bands; and
perform integrating processing on the frequency domain signal features in the at least two frequency bands, to obtain the speech speed feature of the audio data to be recognized.

In an example, the second determination module 7022 is specifically configured to:
input the audio data to be recognized into the preset second feature extraction model for feature extraction, to obtain output semantic feature of the audio data to be recognized.

In an example, the image generation unit 703 includes:
an image generation module, configured to input the speech speed feature and the semantic feature into a preset model for determining a mouth shape of a face for processing, and generate, according to a result obtained from the processing and the preset face image, the face image having the mouth shape.

In an example, the image generation module includes:
a feature splicing sub-module, configured to perform, based on the preset model for determining the mouth shape of the face, splicing processing on the speech speed feature and the semantic feature, to obtain a spliced feature of the audio data to be recognized; where the spliced feature represents the speech speed feature and the semantic feature;
a parameter determination sub-module, configured to perform, according to a convolutional layer in the preset model for determining the mouth shape of the face, feature extraction on the spliced feature, to obtain a face driving parameter; where the face driving parameter is used for representing a parameter required to drive a mouth shape in a face image to make changes; and
an image rendering sub-module, configured to perform, according to the face driving parameter, image rendering on the preset face image, to generate the face image having the mouth shape.

In an example, the face driving parameter is a weight parameter of a blend shape; and the image rendering sub-module is specifically configured to:
determine, according to the weight parameter of the blend shape, facial three-dimensional mesh data corresponding to the preset face image; where the facial three-dimensional mesh data is data representing a three-dimensional mesh model of a facial surface on a face image; and
perform, according to the facial three-dimensional mesh data, image rendering on the preset face image, to generate the face image having the mouth shape.

In an example, the following is further included:
a semantic processing unit, configured to: if it is determined that a value represented by the speech speed feature of the audio data to be recognized is less than a preset speech speed threshold value, perform, according to the semantic feature, processing on the preset face image, to generate a face image having a mouth shape.

FIG. 8 is a structural diagram of an apparatus for training a model for determining a mouth shape of a face provided by an embodiment of the present disclosure. For ease of illustration, only parts relevant to the embodiment of the present disclosure are shown. Referring to FIG. 8, the apparatus for training the model for determining the mouth shape of the face includes: an image acquisition unit 801, a feature extraction unit 802, a model training unit 803, and a model obtaining unit 804.

The image acquisition unit 801 is configured to acquire image data to be trained and a preset face image; where the image data to be trained includes audio data to be trained and a face image to be trained, the face image to be trained having a mouth shape corresponding to the audio data to be trained;
the feature extraction unit 802 is configured to determine an audio feature of the audio data to be trained; where the audio feature includes a speech speed feature and a semantic feature;
the model training unit 803 is configured to perform, according to the speech speed feature, the semantic feature, and the preset face image, training on an initial model for determining a mouth shape of a face, and obtain a face image having a mouth shape; and
the model obtaining unit 804 is configured to determine that a trained model for determining a mouth shape of a face is obtained if the face image having the mouth shape and the face image to be trained are consistent.

In an example, the feature extraction unit 802 includes:
a first extraction module, configured to determine, according to a preset first feature extraction model, a speech speed feature of the audio data to be trained; where the first feature extraction model is used for extracting the speech speed feature from the audio data to be trained; and
a second extraction module, configured to determine, according to a preset second feature extraction model, a semantic feature of the audio data to be trained; where the second feature extraction model is used for extracting the semantic feature from the audio data to be trained.

In an example, the first extraction module includes:
a probability determination sub-module, configured to input the audio data to be trained into the preset first feature extraction model for feature extraction, to obtain a phonetic posterioriorgram feature of the audio data to be trained; where the phonetic posterioriorgram feature represents information about a phoneme category of the audio data to be trained; and
a speech speed determination sub-module, configured to determine, according to the phonetic posterioriorgram feature of the audio data to be trained, the speech speed feature of the audio data to be trained.

In an example, the speech speed determination sub-module is specifically configured to:
perform a fast Fourier transform processing on the phonetic posterioriorgram feature to obtain a frequency domain signal feature; where the frequency domain signal feature represents information about the phoneme category of the audio data to be trained;
slice, according to a preset frequency band size, the frequency domain signal feature into frequency domain signal features in at least two frequency bands; and
perform integrating processing on the frequency domain signal features in the at least two frequency bands, to obtain the speech speed feature of the audio data to be trained.

In an example, the second extraction module is specifically configured to:
input the audio data to be trained into the preset second feature extraction model for feature extraction, to obtain output semantic feature of the audio data to be trained.

In one example, the model training unit 803 includes:
a feature splicing module, configured to perform, based on the initial model for determining the mouth shape of the face, splicing processing on the speech speed feature and the semantic feature, to obtain a spliced feature of the audio data to be trained; where the spliced feature represents the speech speed feature and the semantic feature;
a parameter determination module, configured to perform, according to a convolutional layer in the initial model for determining the mouth shape of the face, feature extraction on the spliced feature, to obtain a face driving parameter; where the face driving parameter is used for representing a parameter required to drive a mouth shape in a face image to make changes; and
an image rendering module, configured to perform, according to the face driving parameter, image rendering on the preset face image, to obtain the face image having the mouth shape.

In an example, the face driving parameter is a weight parameter of a blend shape; and the image rendering module includes:
a data determination sub-module, configured to determine, according to the weight parameter of the blend shape, facial three-dimensional mesh data corresponding to the preset face image; where the facial three-dimensional mesh data is data representing a three-dimensional mesh model of a facial surface on a face image; and
an image rendering sub-module, configured to perform, according to the facial three-dimensional mesh data, image rendering on the preset face image, to generate the face image having the mouth shape.

In an example, the image acquisition unit 801 includes:
a data acquisition module, configured to acquire the audio data to be trained;
a three-dimensional reconstruction module, configured to perform, according to the audio data to be trained, three-dimensional reconstruction processing of a face image, to obtain facial three-dimensional mesh data corresponding to the audio data to be trained; and
an image obtaining module, configured to obtain, according to the facial three-dimensional mesh data corresponding to the audio data to be trained, the face image to be trained.

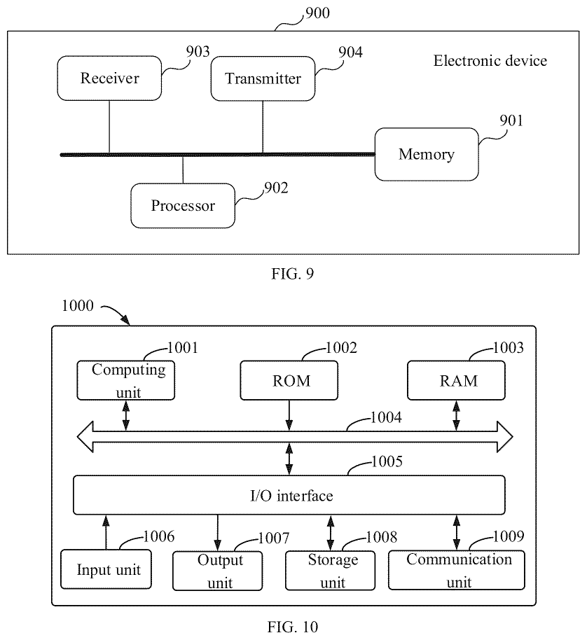

FIG. 9 is a structural diagram of an electronic device provided by an embodiment of the present disclosure, and as shown in FIG. 9, the electronic device 900 includes: at least one processor 902; and a memory 901 communicatively connected to the at least one processor 902; where the memory stores an instruction executable by the at least one processor 902, and the instruction is executed by the at least one processor 902 to enable the at least one processor 902 to execute the mouth shape-based method for generating a face image and the method for training a model in the present disclosure.

The electronic device 900 further includes a receiver 903 and a transmitter 904. The receiver 903 is configured to receive an instruction and data sent by other devices, and the transmitter 904 is configured to send an instruction and data to external devices.

According to an embodiment of the present disclosure, the present disclosure further provides an electronic device, a readable storage medium, and a computer program product.

According to an embodiment of the present disclosure, the present disclosure further provides a computer program product, the computer program product including: a computer program stored in a readable storage medium, where at least one processor of the electronic device may read the computer program from the readable storage medium, and the at least one processor executes the computer program to enable the electronic device to execute the solution provided by any one of the aforementioned embodiments.

FIG. 10 shows a schematic block diagram of an example electronic device 1000 which can be configured to implement the embodiments of the present disclosure. The electronic device is intended to represent various forms of digital computers, for example, a laptop, a desktop computer, a workstation, a personal digital assistant, a server, a blade server, a mainframe computer, and other suitable computers. The electronic device may also represent various forms of mobile apparatuses, for example, a personal digital assistant, a cellular telephone, a smart phone, a wearable device, and other similar computing apparatuses. Components, connections and relationships thereof, and functions thereof shown herein are used as examples only, and are not intended to limit implementations of the present disclosure described and/or claimed herein.

As shown in FIG. 10, the device 1000 includes a computing unit 1001 which can perform various appropriate actions and processes according to a computer program stored in a read only memory (ROM) 1002 or loaded from a storage unit 1008 into a random access memory (RAM) 1003. In the RAM 1003, various programs and data required for operations of the device 1000 may also be stored. The computing unit 1001, the ROM 1002, and the RAM 1003 are connected to each other via a bus 1004. An input/output (I/O) interface 1005 is also connected to the bus 1004.

A plurality of components in the device 1000 are connected to the I/O interface 1005, including: an input unit 1006, for example, a keyboard, mouse, etc.; an output unit 1007, for example, various types of displays, speakers, etc.; a storage unit 1008, for example, a magnetic disk, an optical disk, etc.; and a communication unit 1009, for example, a network card, a modem, a wireless communication transceiver, etc. The communication unit 1009 allows the device 1000 to exchange information/data with other devices via a computer network such as the Internet and/or various telecommunication networks.

The computing unit 1001 may be various general-purpose and/or dedicated processing components with processing and computing capabilities. Some examples of the computing unit 1001 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 1001 performs the various methods and processes described above, for example, the mouth shape-based method for generating a face image and the method for training a model. For example, in some embodiments, the mouth shape-based method for generating a face image and the method for training a model may be implemented as a computer software program which is tangibly contained in a machine readable medium, for example, the storage unit 1008. In some embodiments, some or all of computer programs may be loaded and/or installed onto the device 1000 via the ROM 1002 and/or the communication unit 1009. When the computer program is loaded into the RAM 1003 and executed by the computing unit 1001, one or more steps of the mouth shape-based method for generating a face image and the method for training a model described above may be executed. Alternatively, in other embodiments, the computing unit 1001 may be configured to perform the mouth shape-based method for generating a face image and the method for training a model by any other suitable means (e.g., by means of firmware).

Various implementation modes of systems and techniques described above herein may be realized in a digital electronic circuit system, an integrated circuit system, a field programmable gate array (FPGA), an application-specific integrated circuit (ASIC), an application-specific standard product (ASSP), a system of a system-on-chip (SOC), a complex programmable logic device (CPLD), computer hardware, firmware, software, and/or a combination thereof. These various implementation modes may include: being implemented in one or more computer programs, where the one or more computer programs may be executed and/or interpreted on a programmable system including at least one programmable processor, and the programmable processor may be a dedicated or general-purpose programmable processor which may receive data and instructions from a storage system, at least one input apparatus, and at least one output apparatus, and transmit data and instructions to the storage system, the at least one input apparatus, and the at least one output apparatus.

Program codes for implementing the methods of the present disclosure may be written in any combination of one or more programming languages. These program codes may be provided to a processor or controller of a general-purpose computer, a dedicated computer, or other programmable data processing apparatuses, to cause functions/operations specified in the flowcharts and/or block diagrams to be implemented when the program codes are executed by the processor or the controller. The program codes may be executed entirely on a machine, executed partially on a machine, executed partially on a machine as a stand-alone software package and executed partially on a remote machine or executed entirely on a remote machine or a server.

In the context of the present disclosure, a machine readable medium may be a tangible medium which may contain or store a program for use by or in combination with an instruction execution system, an apparatus, or a device. The machine readable medium may be a machine readable signal medium or a machine readable storage medium. The machine readable medium may include, but is not limited to, an electronic, magnetic, optical, electromagnetic, infrared, or semiconductor system, device, or apparatus, or any suitable combination of the foregoing. More specific examples of the machine readable storage medium may include electrical connections based on one or more wires, a portable computer disk, a hard disk, a random access memory (RAM), a read only memory (ROM), an erasable programmable read only memory (EPROM), or a flash memory, an optical fiber, a portable compact disk-read only memory (CD-ROM), an optical storage device, a magnetic storage device, or any suitable combination of the foregoing.

To provide interaction with a user, the systems and the techniques described herein may be implemented on a computer having: a display apparatus (e.g., a CRT (cathode ray tube) or LCD (liquid crystal display) monitor) configured to display information to the user; and a keyboard and a pointing apparatus (e.g., a mouse or a trackball) by which the user can provide input to the computer. Other kinds of apparatuses may also be used to provide interaction with the user; for example, a feedback provided to the user may be any form of sensory feedback (e.g., a visual feedback, an auditory feedback, or a haptic feedback); and input from the user may be received in any form (including acoustic input, voice input, or, haptic input).

The systems and the techniques described herein may be implemented in a computing system which includes a back-end component (e.g., as a data server), or a computing system which includes a middleware component (e.g., an application server), or a computing system which includes a front-end component (e.g., a user computer having a graphical user interface or a web browser through which a user can interact with the systems and the techniques described herein), or a computing system which includes any combination of such back-end component, middleware component, or front-end component. Components of a system may be interconnected by digital data communication (e.g., a communication network) in any form or medium. Examples of the communication network include: a local area network (LAN), a wide area network (WAN), and the Internet.

A computer system may include a client and a server. The client and the server are generally far away from each other and usually interact over a communication network. A client-server relationship is created by computer programs which run on corresponding computers and have a client-server relationship with each other. The server may be a cloud server, also referred to as cloud computing server or cloud host, which is a host product in the cloud computing service system to address shortcomings of large management difficulty and weak service scalability in traditional physical hosts and VPS (Virtual Private Server) services. The server may also be a server for a distributed system, or a server in combination with a blockchain.

It should be understood that various forms of the processes shown above may be used, with steps reordered, added or deleted. For example, steps recited in the present disclosure may be executed in parallel or sequentially or in a different order, as long as desired results of technical solutions disclosed in the present disclosure can be achieved, and are not limited herein.

The aforementioned embodiments do not constitute a limitation on protection scope of the present disclosure. It should be apparent to those skilled in the art that various modifications, combinations, sub-combinations and substitutions may be made depending on design requirements and other factors. Any modifications, equivalent substitutions and improvements made within spirit and principles of the present disclosure should be contained in the protection scope of the present disclosure.

1. A mouth shape-based method for generating a face image, comprising:
acquiring audio data to be recognized and a preset face image;
determining an audio feature of the audio data to be recognized; wherein the audio feature comprises a speech speed feature and a semantic feature; and
performing, according to the speech speed feature and the semantic feature, processing on the preset face image, to generate a face image having a mouth shape.

2. The method according to claim 1, wherein the determining the audio feature of the audio data to be recognized comprises:
determining, according to a preset first feature extraction model, a speech speed feature of the audio data to be recognized; wherein the first feature extraction model is used for extracting the speech speed feature from the audio data to be recognized; and
determining, according to a preset second feature extraction model, a semantic feature of the audio data to be recognized; wherein the second feature extraction model is used for extracting the semantic feature from the audio data to be recognized.

3. The method according to claim 2, wherein the determining, according to the preset first feature extraction model, the speech speed feature of the audio data to be recognized comprises:
inputting the audio data to be recognized into the preset first feature extraction model for feature extraction, to obtain a phonetic posterioriorgram feature of the audio data to be recognized; wherein the phonetic posterioriorgram feature represents information about a phoneme category of the audio data to be recognized; and
determining, according to the phonetic posterioriorgram feature of the audio data to be recognized, the speech speed feature of the audio data to be recognized.

4. The method according to claim 3, wherein the determining, according to the phonetic posterioriorgram feature of the audio data to be recognized, the speech speed feature of the audio data to be recognized comprises:
performing a fast Fourier transform processing on the phonetic posterioriorgram feature to obtain a frequency domain signal feature; wherein the frequency domain signal feature represents information about the phoneme category of the audio data to be recognized;
slicing, according to a preset frequency band size, the frequency domain signal feature into frequency domain signal features in at least two frequency bands; and
performing integrating processing on the frequency domain signal features in the at least two frequency bands, to obtain the speech speed feature of the audio data to be recognized.

5. The method according to claim 2, wherein the determining, according to the preset second feature extraction model, the semantic feature of the audio data to be recognized comprises:
inputting the audio data to be recognized into the preset second feature extraction model for feature extraction, to obtain output semantic feature of the audio data to be recognized.

6. The method according to claim 1, wherein the performing, according to the speech speed feature and the semantic feature, the processing on the preset face image, to generate the face image having the mouth shape comprises:
inputting the speech speed feature and the semantic feature into a preset model for determining a mouth shape of a face for processing, and generating, according to a result obtained from the processing and the preset face image, the face image having the mouth shape.

7. The method according to claim 6, wherein the inputting the speech speed feature and the semantic feature into the preset model for determining the mouth shape of the face for the processing, and the generating, according to the result obtained from the processing and the preset face image, the face image having the mouth shape comprise:
performing, based on the preset model for determining the mouth shape of the face, splicing processing on the speech speed feature and the semantic feature, to obtain a spliced feature of the audio data to be recognized; wherein the spliced feature represents the speech speed feature and the semantic feature;
performing, according to a convolutional layer in the preset model for determining the mouth shape of the face, feature extraction on the spliced feature, to obtain a face driving parameter; wherein the face driving parameter is used for representing a parameter required to drive a mouth shape change in a face image; and
performing, according to the face driving parameter, image rendering on the preset face image, to generate the face image having the mouth shape.

8. The method according to claim 7, wherein the face driving parameter is a weight parameter of a blend shape; and the performing, according to the face driving parameter, the image rendering on the preset face image, to generate the face image having the mouth shape comprises:
determining, according to the weight parameter of the blend shape, facial three-dimensional mesh data corresponding to the preset face image; wherein the facial three-dimensional mesh data is data representing a three-dimensional mesh model of a facial surface on a face image; and
performing, according to the facial three-dimensional mesh data, image rendering on the preset face image, to generate the face image having the mouth shape.

9. The method according to claim 1, further comprising:
if it is determined that a value represented by the speech speed feature of the audio data to be recognized is less than a preset speech speed threshold value, performing, according to the semantic feature, processing on the preset face image, to generate the face image having the mouth shape.

10. A method for training a model for determining a mouth shape of a face, comprising:
acquiring image data to be trained and a preset face image; wherein the image data to be trained comprises audio data to be trained and a face image to be trained, and the face image to be trained has a mouth shape corresponding to the audio data to be trained;
determining an audio feature of the audio data to be trained; wherein the audio feature comprises a speech speed feature and a semantic feature;
performing, according to the speech speed feature, the semantic feature, and the preset face image, training on an initial model for determining a mouth shape of a face, and obtaining a face image having a mouth shape; and
if the face image having the mouth shape and the face image to be trained are consistent, determining that a trained model for determining a mouth shape of a face is obtained.

11. The method according to claim 10, wherein the determining the audio feature of the audio data to be trained comprises:
determining, according to a preset first feature extraction model, a speech speed feature of the audio data to be trained; wherein the first feature extraction model is used for extracting the speech speed feature from the audio data to be trained; and
determining, according to a preset second feature extraction model, a semantic feature of the audio data to be trained; wherein the second feature extraction model is used for extracting the semantic feature from the audio data to be trained.

12. The method according to claim 11, wherein the determining, according to the preset first feature extraction model, the speech speed feature of the audio data to be trained comprises:
inputting the audio data to be trained into the preset first feature extraction model for feature extraction, to obtain a phonetic posterioriorgram feature of the audio data to be trained; wherein the phonetic posterioriorgram feature represents information about a phoneme category of the audio data to be trained; and
determining, according to the phonetic posterioriorgram feature of the audio data to be trained, the speech speed feature of the audio data to be trained; and
wherein the determining, according to the preset second feature extraction model, the semantic feature of the audio data to be trained comprises:
inputting the audio data to be trained into the preset second feature extraction model for feature extraction, to obtain output semantic feature of the audio data to be trained.

13. The method according to claim 12, wherein the determining, according to the phonetic posterioriorgram feature of the audio data to be trained, the speech speed feature of the audio data to be trained comprises:
performing a fast Fourier transform processing on the phonetic posterioriorgram feature to obtain a frequency domain signal feature; wherein the frequency domain signal feature represents information about the phoneme category of the audio data to be trained;
slicing, according to a preset frequency band size, the frequency domain signal feature into frequency domain signal features in at least two frequency bands; and
performing integrating processing on the frequency domain signal features in the at least two frequency bands, to obtain the speech speed feature of the audio data to be trained.

14. (canceled)

15. The method according to claim 10, wherein the performing, according to the speech speed feature, the semantic feature, and the preset face image, the training on the initial model for determining the mouth shape of the face, and the obtaining the face image having the mouth shape comprise:
performing, based on the initial model for determining the mouth shape of the face, splicing processing on the speech speed feature and the semantic feature, to obtain a spliced feature of the audio data to be trained; wherein the spliced feature represents the speech speed feature and the semantic feature;
performing, according to a convolutional layer in the initial model for determining the mouth shape of the face, feature extraction on the spliced feature, to obtain a face driving parameter; wherein the face driving parameter is used for representing a parameter required to drive a mouth shape change in a face image; and
performing, according to the face driving parameter, image rendering on the preset face image, to obtain the face image having the mouth shape.

16. The method according to claim 15, wherein the face driving parameter is a weight parameter of a blend shape; and the performing, according to the face driving parameter, the image rendering on the preset face image, to obtain the face image having the mouth shape comprises:
determining, according to the weight parameter of the blend shape, facial three-dimensional mesh data corresponding to the preset face image; wherein the facial three-dimensional mesh data is data representing a three-dimensional mesh model of a facial surface on a face image; and
performing, according to the facial three-dimensional mesh data, image rendering on the preset face image, to generate the face image having the mouth shape.

17. The method according to claim 10, wherein the acquiring the image data to be trained comprises:
acquiring the audio data to be trained;
performing, according to the audio data to be trained, three-dimensional reconstruction processing of a face image, to obtain facial three-dimensional mesh data corresponding to the audio data to be trained; and
obtaining, according to the facial three-dimensional mesh data corresponding to the audio data to be trained, the face image to be trained.

18. A mouth shape-based apparatus for generating a face image, comprising:
at least one processor; and
a memory communicatively connected to the at least one processor; wherein
the memory stores an instruction executable by the at least one processor, and the instruction is executed by the at least one processor to enable the at least one processor to:
acquire audio data to be recognized and a preset face image;
determine an audio feature of the audio data to be recognized; wherein the audio feature comprises a speech speed feature and a semantic feature; and
perform, according to the speech speed feature and the semantic feature, processing on the preset face image, to generate a face image having a mouth shape.

19-26. (canceled)

27. An apparatus for training a model for determining a mouth shape of a face, comprising:
at least one processor; and
a memory communicatively connected to the at least one processor; wherein
the memory stores an instruction executable by the at least one processor, and the instruction is executed by the at least one processor to enable the at least one processor to execute the method according to claim 10.

28-35. (canceled)

36. A non-transitory computer readable storage medium storing a computer instruction, wherein the computer instruction is used for enabling a computer to execute the method according to claim 1.

37. (canceled)

38. A non-transitory computer readable storage medium storing a computer instruction, wherein the computer instruction is used for enabling a computer to execute the method according to claim 10.
